(19) United States
(12) Patent Application Publication
(10) Pub. No.: US 2010/0296007 A1
(43) Pub. Date: Nov. 25, 2010

(54) SYSTEM AND METHOD FOR UPDATING A CABLE TELEVISION CHANNEL MAP

(75) Inventor: Steven L. Cooper, Whitestown, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen, Guangdong (CN)

(21) Appl. No.: 12/812,422

(22) PCT Filed: Apr. 1, 2008
(86) PCT No.: PCT/US08/59053

§ 371 Date: Jul. 9, 2010

(30) Foreign Application Priority Data
Feb. 3, 2008 (CN) 200810065351.5

(51) Int. Cl. H04N 5/50

(52) U.S. Cl. 348/731; 348/E05.097

(57) ABSTRACT

There is provided a system and method for updating a cable television channel map. More specifically, in one embodiment, there is provided a method comprising determining whether channels in a scan list are not available to the user, marking these channels as removed, and notifying the user of the changes.

### FIELD OF THE INVENTION

The present invention relates generally to managing television operation, and more particularly to updating a cable television channel map.

### BACKGROUND OF THE INVENTION

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

A channel map may be defined as a list of television channels present in a given cable lineup. Channel maps for cable systems are generally transmitted by a cable provider to a user's television from a cable head end via a channel map source, such as a Personal Computer Memory Card International Association (PCMCIA) CableCard.

A channel search cannot be performed when using a CableCard. This is because CableCard specification SCTE 65 provides that the channel map is provided by the CableCard through the extended channel interface. The cable provider, through the CableCard, decides what channels are available to the user and the host does not make this determination. There are cases where channels that are available to the user without the CableCard are no longer available to the user after the CableCard is inserted. The user could possibly find these channels by performing a channel search without the CableCard, but it would be difficult due to the sheer number of channels (many of which are encrypted and cannot be viewed without the CableCard) and the slow tuning times for digital channels. Therefore, it is not really possible for the user to watch both his subscribed, encrypted channels and the channels that are hidden by the CableCard channel map. In addition, channel numbers are often changed by the cable head end via the CableCard and the provided channel map.

Channel numbers determined without the CableCard are based upon the NCTA standard, which maps a given frequencies to channel “numbers.” CableCards break this mapping scheme and allow for a completely different frequency to channel number mapping. Therefore, channels found during a normal channel search without the CableCard may not correspond in any way to those that are presented by the CableCard. For example, the terrestrial channels are often re-mapped on standard cable so that the signal broadcast over the air will not cause undo interference with the same signal on the cable system. Hence, channel 13 terrestrial might be re-mapped to channel 12 on the normal cable system. However, with the CableCard the channel number presented to the user does not necessarily correspond to the physical channel anymore. Therefore, this physical cable channel 12 is mapped to the virtual cable channel 13 so that it is more understandable to the user. This means that the normal channel search would not be useful for determining what channels may or may not exist when the CableCard is inserted.

With the CableCard inserted, there is no need to perform a channel search because the channel map is provided by the cable head end via the CableCard. The problem is that the cable head end sends a channel map that shows all potential channels, including ones that are not available to the user through their subscribed package. With a few exceptions, all channels can be tuned, but if they are not available to the user, the channels cannot be viewed. Thus, the user is presented with all the channels sent by the CableCard head end, many of which are not available to the user. Some examples of channels not available to the user are: 1) channels that have weak or no signals, 2) channels that are encrypted or the user is not otherwise authorized to view, and 3) channels that contain no audio or video data. This situation becomes cumbersome when trying to navigate the channel map by using channel up and down and a large block of channels unavailable to the user is encountered. Most often the user has no idea which channels are not available to him so a direct digit entry or manual search using channel up or down is required for a user to find the few valid channels among the many invalid channels.

To remove the invalid channels from the normal channel up/down “scan list,” the user may enter a menu where all possible cable channels are listed and manually mark as “removed” the channels that are either invalid or undesired. These channels are not actually removed from the map and are still displayed. However, the user choice to skip the channel is added to the database entry for that channel. This data is then used to skip over the marked channels while performing channel navigation using channel up or down buttons. In many cases, performing a direct-digit entry would still result in attempting to watch the marked channel. However, this is now the only option to remove invalid channels presented by the CableCard.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a block diagram of a channel map processing unit in accordance with an exemplary embodiment of the present invention; and

FIG. 3 is a process flow diagram representing a procedure for updating a cable television channel map in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As set forth below, embodiments of the present invention are directed to updating a cable television channel map. More specifically, embodiments of the present invention are directed to marking channels as removed in a scan list whenever the channels are not available to a user. This is generally achieved by automatically scanning each channel and updating the status of each channel in the user's scan list.

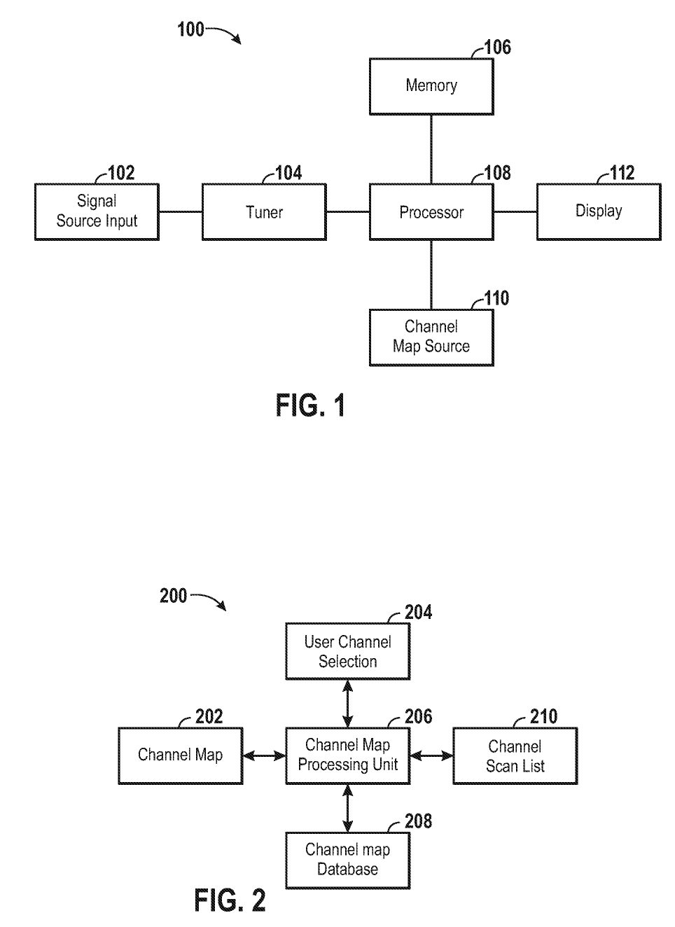

FIG. 1 is a block diagram of an electronic device in accordance with an exemplary embodiment of the present invention. The electronic device (e.g., a television) is generally referred to by the reference number 100. The electronic device 100 comprises a signal source input 102 (e.g., a cable inlet), a tuner 104, a memory 106, a processor 108, a channel map source 110, and a display 112.

The signal source input 102 may comprise an RCA input, an s-video input, a composite video input or the like. The signal source input 102 is adapted to receive a signal that comprises video or audio data that includes the program title information. The title information is provided as part of a typical broadcast signal using, for example, Program and System Information Protocol (PSIP) or Extended Data Services (XDS) data. A tuner 104 is adapted to tune a particular audio or video program title from a broadcast signal received from the signal source input 102. The memory 106 may be adapted to hold machine-readable computer code that causes the processor 108 to control the operation of the electronic device 100. The processor 108 may receive cable channel map data and/or other information from a service provider (e.g., a cable provider) via a channel map source 110 that is external or internal to the electronic device 100. The channel map source 110 may include a cable box, a PCMCIA CableCard, or the like. A display 112 may comprise a television, a monitor, or any other suitable display type.

Those of ordinary skill in the art will appreciate that the various functional blocks shown in FIG. 1 may comprise hardware elements (including circuitry), software elements (including computer code stored on a machine-readable medium), or a combination of both hardware and software elements.

FIG. 2 is a block diagram of a channel map processing unit in accordance with an exemplary embodiment of the present invention. Specifically, FIG. 2 illustrates a cable channel map 202 that may be provided through the channel map source 110 of FIG. 1. The channel map 202 may originate from a service provider (e.g., a cable provider) or a device (e.g., the channel map source 110). The channel map 202 may be processed in block 204 by a channel map processing unit 206 and added to a channel map database 208 stored in random access memory (RAM), non-volatile memory (NVM) or the like. For example, mapping channels and storing them in memory may include searching available channels and mapping those with a sufficiently clear signal into the channel map database 208.

Block 204 of FIG. 2 represents selection of channels for display by a user. For example, this may include selecting certain channel numbers via a “channel up” or “channel down” button on a television panel or remote control for display of the associated content on a television screen. If the user selects a channel that is not available (e.g., the channel has a weak signal, is encrypted, or contains no audio/video data), the condition of the channel may be detected and the user may be notified and prompted to keep or remove the channel in the scan list. For example, as illustrated by block 210, upon detecting PSIP or XDS data indicating an unavailable channel, an alert may be initiated in an on-screen display that indicates that the channel is unavailable.

As discussed above, the process of removing unavailable channels from a user's scan list is a manual process when using CableCards. However, it is possible to automatically perform what would otherwise be the manual process of scanning each channel and marking the unavailable channels as “removed” in the scan list. Accordingly, in one exemplary embodiment of the present invention, after a CableCard channel map has been received, a menu option may become available to perform an automatic scan of all CableCard channel map channels. The actual scanning of channels would be performed by executing a channel up (or down) function over and over until each channel in the channel map has been scanned. During the scan, if a channel is determined to be unavailable, it would be automatically marked as removed from the user's scan list.

In another exemplary embodiment of the present invention, the user may choose a menu option to remove all unavailable channels in the background, using appropriate hardware such as tuners and transports, if available, or while the device is in standby. In either case, all channels could be continuously monitored, adding and removing any unavailable channels when their statuses change. Thus, for example, if there were a “Free HBO weekend,” the newly found available channels could be added back to the user's scan list. Additionally, in this embodiment, notification could be provided to the user when the device is turned on to inform them of newly available or removed channels.

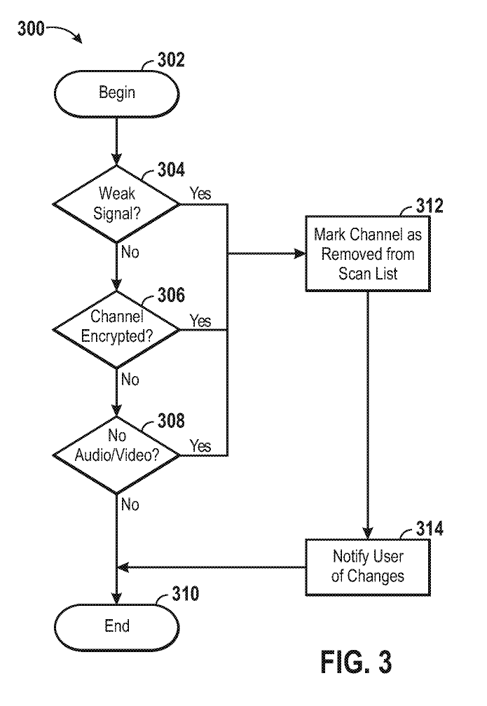

FIG. 3 is a process flow diagram representing a procedure for updating a cable television channel map in accordance with an exemplary embodiment of the present invention. The procedure is generally indicated by reference numeral 300. As illustrated by block 302, the procedure 300 may begin based on any number of events. For example, the procedure may be initiated either by user selection or upon some predetermined event (e.g. device startup). Next, in blocks 304, 306, and 308, each channel is analyzed to determine whether it is unavailable. Determining whether a channel is unavailable may include whether the channel: 1) has a weak or no signal, 2) is encrypted or the user is not otherwise authorized to view it, or 3) has a good signal, is not encrypted, but has no audio or video data. If the channel is not determined to be unavailable, the procedure ends at block 310. If the channel is found to be unavailable, the channel is marked as removed in the scan list and the user is notified of the changes, as illustrated by blocks 312 and 314.

Specifically, determining whether the selected channel is not available to the user may include determining a status of the channel, a level of signal strength associated with the channel and/or content associated with the channel. Indeed, in the illustrated embodiment of FIG. 3, block 304 represents determining whether the signal for the channel is weak. For example, a measure of the channel's signal strength may be compared to a threshold value, and the channel may be considered too weak if the threshold value is not exceeded. This threshold value may be defined by a user. If the channel is not too weak, a determination of whether the signal for the channel is encrypted may be made, as illustrated in block 306. For example, the user may not be authorized to access the content associated with the channel. Further, in some embodiments, the channels may be analyzed to determine if any are lacking audio or video data, as illustrated by block 308. If the channel is not weak, not encrypted, and contains video and audio data, the procedure 300 may end, as illustrated by block 310, without marking the channel for removal. In one exemplary embodiment, one or more of the functions represented by blocks 304, 306, and 308 is not performed at all. In addition, the functions represented in blocks 304, 306, and 308 are meant to be merely illustrative and not an exhaustive list of potential functions to determine whether channels are unavailable to the user.

It should also be noted that in some embodiments, the order associated with blocks 304, 306, and 308 may be different. For example, it may be desirable to determine whether the selected channel is encrypted (block 306) before determining whether it is weak (block 304). However, it may be desirable to detect whether a channel is weak (block 304) first to facilitate efficient evaluation of whether the channel is potentially objectionable. For example, if the channel is confirmed to be weak, it may not be necessary to determine whether the content associated with the channel is otherwise objectionable, which may save evaluation time.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An electronic device, comprising:
a channel map source that is adapted to provide a channel map; and
a processor that is adapted to scan the channel map to identify channels not available to a user, and to mark the channels not available to the user as removed in a channel scan list.

2. The electronic device of claim 1, wherein the channel map source is a CableCard.

3. The electronic device of claim 1, wherein the processor is adapted to identify channels not available to a user because their signals are weak.

4. The electronic device of claim 1, wherein the processor is adapted to identify channels not available to a user because they are encrypted or the user is not otherwise authorized to view them.

5. The electronic device of claim 1, wherein the processor is adapted to identify channels not available to a user because they contain no video or audio data.

6. The electronic device of claim 1, wherein the processor is adapted to identify channels not available to a user because they are associated with objectionable content.

7. The electronic device of claim 1, wherein the processor is adapted to identify channels not available to a user upon some predetermined system event.

8. The electronic device of claim 1, wherein the processor is adapted to identify channels not available to a user upon prompting by the user to perform the identification process.

9. The electronic device of claim 1, wherein the processor is further adapted to notify the user of changes subsequently to marking the channels not available to the user as removed in the channel scan list.

10. The electronic device of claim 1, wherein the processor is further adapted to identify channels available to a user and to mark the channels available to the user as available in the channel scan list.

11. A method, comprising:
receiving a channel map via a channel map source;
scanning the channel map subsequently to receiving the channel map to identify channels not available to a user; and
marking the channels not available to the user as removed in a channel scan list.

12. The method of claim 11, wherein the channel map source is a CableCard.

13. The method of claim 11, wherein the channels are identified as not available to a user because their signals are weak.

14. The method of claim 11, wherein the channels are identified as not available to a user because they are encrypted or the user is not otherwise authorized to view them.

15. The method of claim 11, wherein the channels are identified as not available to a user because they contain no video or audio data.

16. The method of claim 11, wherein the channels are identified as not available to a user because they are associated with objectionable content.

17. The method of claim 11, wherein the channels are identified as not available to a user upon prompting by the user to perform the identification process.

18. The method of claim 11, further comprising notifying the user of changes subsequently to marking the channels not available to the user as removed in the channel scan list.

19. The method of claim 11, further comprising identifying channels available to a user and marking the channels available to the user as available in the channel scan list.

20. An electronic device, comprising:
means for receiving a channel map;
means for scanning the channel map subsequently to receiving the channel map to identify channels not available to a user; and
means for marking the channels not available to the user as removed in a channel scan list.
